(19) United States
(12) Patent Application Publication
(10) Pub. No.: US 2021/0318113 A1
(43) Pub. Date: Oct. 14, 2021

(54) Method for wall surface calibration, method for edge calibration, calibration apparatus, and computer program product

(71) Applicant: IVIEW DISPLAYS (SHENZHEN) COMPANY LTD.

(72) Inventors: Wenxiang Li, Shenzhen (CN); Mingnei Ding, Shenzhen (CN); Steve Yeung, Shenzhen (CN); Zhiqiang Gao, Shenzhen (CN)

(21) Appl. No.: 17/226,572

(22) Filed: Apr. 9, 2021

Related U.S. Application Data
(63) Continuation of application No. PCT/CN2020/125340, filed on Oct. 30, 2020.

(30) Foreign Application Priority Data
Apr. 10, 2020 (CN) 202010278027.2

(51) Int. Cl. G01B 11/00; G01B 11/24

(52) U.S. Cl. CPC G01B 11/005; G01B 11/24

(57) ABSTRACT

Embodiments of the disclosure provide a method for wall surface calibration, a method for edge calibration, a calibration apparatus, and a computer program product. The method for wall surface calibration comprises: acquiring a first rotation parameter and a second rotation parameter when a center of a projection picture of the calibration apparatus directly faces two boundary points on a top edge of the wall surface respectively; acquiring a third rotation parameter and a fourth rotation parameter when the center of the projection picture of the calibration apparatus directly faces two boundary points on a bottom edge of the wall surface respectively; and determining a surface calibration parameter of the wall surface relative to the calibration apparatus according to the first edge calibration parameter, the second edge calibration parameter, the first rotation parameter, the second rotation parameter, the third rotation parameter and the fourth rotation parameter.

### CROSS-REFERENCE TO RELATED APPLICATIONS

This application is a continuation-application of International (PCT) Patent Application No. PCT/CN2020/125340, filed on Oct. 30, 2020, which claims priority to Chinese Patent Application No. 202010278027.2, filed with the National Intellectual Property Administration of China on Apr. 10, 2020, and entitled “method for wall surface calibration and method for edge calibration”, the entire contents of which are incorporated herein by reference.

### TECHNICAL FIELD

Embodiments of the present disclosure relate to the technical field of space calibration (e.g., coordinate positioning in space), in particular to a method for wall surface calibration, a method for edge calibration, a calibration apparatus, and a computer program product.

### BACKGROUND

Three-dimensional space calibration plays an important role in many applications, such as projection, stage lighting and so on, and belongs to the basic steps of these applications. For example, after the projector equipment acquires spatial three-dimensional information parameters, the deflection angle of the current projection position can be determined, and then geometric correction is performed on the projection picture, so that the projection picture is upright and foursquare. After a stage lamp acquires the space parameters, illumination color and intensity can be adjusted according to the current illumination position, so that a better lighting effect is provided. However, the present inventors have found during the implementation of the present application that at present, most of the existing three-dimensional space calibration technologies rely on complex calibration apparatus, such as a binocular camera, an infrared camera and a 3D depth camera, so that certain equipment burden needs to be increased, and the accuracy of space calibration is often not high.

### SUMMARY

An embodiment of the present disclosure provides a method for wall surface calibration applied to a calibration apparatus, comprising: acquiring a first rotation parameter and a second rotation parameter when a center of a projection picture of the calibration apparatus directly faces two boundary points on a top edge of the wall surface respectively; determining a first edge calibration parameter when the center of the projection picture of the calibration apparatus directly faces the top edge of the wall surface according to the first rotation parameter and the second rotation parameter; acquiring a third rotation parameter and a fourth rotation parameter when the center of the projection picture of the calibration apparatus directly faces two boundary points on a bottom edge of the wall surface respectively; determining a second edge calibration parameter when the center of the projection picture of the calibration apparatus directly faces the bottom edge of the wall surface according to the third rotation parameter and the fourth rotation parameter; and determining a surface calibration parameter of the wall surface relative to the calibration apparatus according to the first edge calibration parameter, the second edge calibration parameter, the first rotation parameter, the second rotation parameter, the third rotation parameter and the fourth rotation parameter.

An embodiment of the present disclosure also provides a method for edge calibration applied to a calibration apparatus, comprising: acquiring a first rotation parameter and a second rotation parameter when a center of a projection picture of the calibration apparatus directly faces two points on an edge to be calibrated respectively; and determining an edge calibration parameter when the center of the projection picture of the calibration apparatus directly faces the edge to be calibrated according to the first rotation parameter and the second rotation parameter.

An embodiment of the present disclosure also provides a calibration apparatus, comprising: at least one processor; and a memory communicatively connected to the at least one processor, wherein the memory stores instructions executable by the at least one processor, and the instructions are executed to enable the at least one processor to perform the method described above.

An embodiment of the present disclosure also provides a computer program product comprising program code which, when run on a calibration apparatus, causes the calibration device to perform the method described above.

### BRIEF DESCRIPTION OF THE DRAWINGS

One or more embodiments are illustrated by way of example in the figures of the accompanying drawings, which are not to be construed as limiting the embodiments. In the accompanying drawings, elements having the same reference numerals represent similar elements and the figures are not to scale unless otherwise indicated.

FIG. 1 is a flow diagram of a method for edge calibration provided by an embodiment of the present disclosure.

FIG. 2 is a schematic diagram showing a rotation angle of a point on an edge to be calibrated provided by the embodiment of the disclosure.

FIG. 3 is a flow diagram of a method for wall surface calibration provided by the embodiment of the present disclosure.

FIG. 4 is a schematic diagram showing a rotation angle of four points on a wall surface provided by the embodiment of the present disclosure.

FIG. 5 is a schematic diagram of a standard cubic space provided by the embodiment of the present disclosure.

FIG. 6 is a schematic diagram of a calibration to a ceiling of a standard space provided by the embodiment of the present disclosure.

FIG. 7 is a schematic diagram of a wall surface calibration and an edge calibration device according to an embodiment of the present disclosure.

FIG. 8 is a schematic diagram of a hardware structure of a calibration apparatus for performing the wall surface and the edge calibration according to the embodiment of the present disclosure.

### DETAILED DESCRIPTION

For more clarity of the purpose, technical scheme and advantages of this disclosure embodiment, a clear and complete description of the technical solution in embodiments of this disclosure will be given below in combination with the appended drawings. It is evident that the described embodiments are part of the present disclosure and not all of it. It should be understood that the specific embodiments described herein are merely illustrative of the present disclosure and are not intended to be limiting thereof. Based on the embodiments in the present disclosure, all other embodiments obtained by a person skilled in the art without involving any inventive effort are within the scope of protection of the present disclosure.

It should be noted that when an element is referred to as being “secured to” another element, it can be directly on the other element, or one or more intervening elements may be present. When an element is referred to as being “connected” to another element, it can be directly connected to the other element, or one or more intervening elements may be present. As used herein, the terms “vertical”, “horizontal”, “left”, “right”, and the like are used for descriptive purposes only.

Furthermore, the technical features referred to in the various embodiments of the present disclosure described below may be combined with each other as long as they do not conflict with each other.

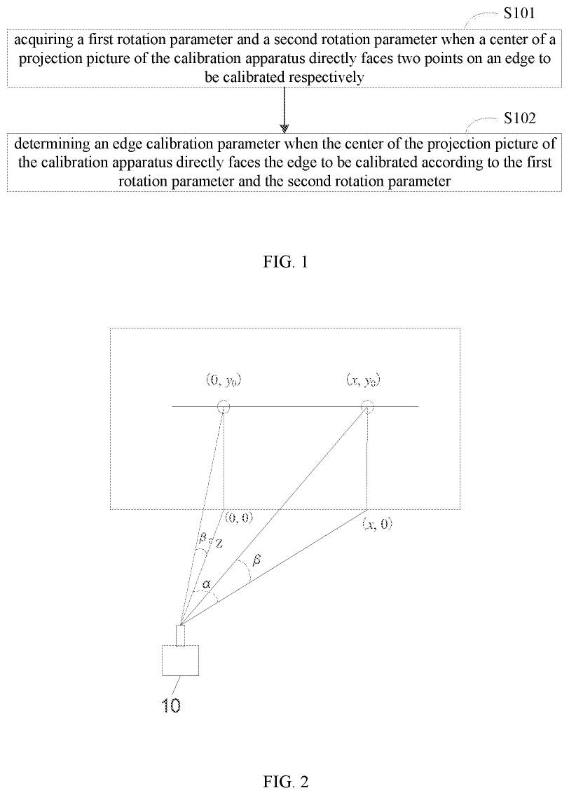

With reference to FIG. 1, it is a flow diagram of a method for edge calibration provided by an embodiment of the present disclosure, applied to a calibration apparatus.

Specifically, the method for edge calibration includes the following operations.

Operation S101, acquiring a first rotation parameter and a second rotation parameter when a center of a projection picture of the calibration apparatus directly faces two points on an edge to be calibrated respectively.

The edge to be calibrated is a horizontal line where the center of the projection picture of the calibration apparatus is located when the calibration apparatus directly faces the wall surface.

Operation S102, determining an edge calibration parameter when a center of the projection picture of the calibration apparatus directly faces the edge to be calibrated according to the first rotation parameter and the second rotation parameter.

The point where the calibration apparatus directly faces the wall surface is a coordinate origin, and the determining an edge calibration parameter when the center of the projection picture of the calibration apparatus directly faces the edge to be calibrated is the determining a vertical rotation angle α₀ and a vertical rotation angle β₀ when the center of the projection picture of the calibration apparatus directly faces the edge to be calibrated.

Referring to FIG. 2, assuming that the distance between the calibration apparatus 10 and the wall surface is denoted as z, the Cartesian coordinate system is established with the point of the calibration apparatus 10 directly facing the wall surface as the origin (0, 0), the x-axis being horizontally to the right, and the y-axis being vertical and upward. For the edge to be calibrated on the wall surface, assuming that the coordinate of the y axis of the edge to be calibrated is y0, the coordinate of the point, which directly faces the calibration apparatus 10, of the edge to be calibrated is (0, y₀); and the rotation angle of the calibration apparatus 10 at the point is (0, β₀), then tan

$${β}_{0} = \frac{{y}_{0}}{z} .$$

If the coordinates of a certain point on the edge to be calibrated can be described as (x, y₀), the rotation angle of the calibration apparatus 10 at the point can be obtained by the following formulas:

$$tan α = \frac{x}{z} , \\ tan β = \frac{{y}_{0}}{\sqrt{{x}^{2} + {z}^{2}}} = \frac{{y}_{0}}{\sqrt{{z}^{2} {tan }^{2} α + {z}^{2}}} = \frac{{y}_{0}}{\sqrt[z]{1 + {tan}^{2} α}} = \frac{{y}_{0}}{z sec α} = tan {β}_{0} cos α .$$

When the vertical rotation angle β₀ of the edge to be calibrated is not 0, the rotation angle (α₀, β₀) of the calibration apparatus 10 can be estimated according to two points on the edge to be calibrated when the rotation angle of the calibration apparatus 10 directly face the wall surface and the center of a projection picture of the calibration apparatus 10 is positioned on the edge to be calibrated.

According to the first rotation parameter (α₁, β₁) and the second rotation parameter (α₂, β₂) acquired when the center of the projection picture of the calibration apparatus directly faces two points on an edge to be calibrated respectively in the operation S101, and according to the analysis, the following formula can be obtained:

tan β₁=tan β₀ cos(α₁−α₀)

tan β₂=tan β₀ cos(α₂−α₀)

Since the edge to be calibrated is not at the same height as the calibration apparatus 10, β₀≠0, and the division of the two formulas can obtain:

$$\frac{tan {β}_{1}}{tan {β}_{2}} = \frac{cos ( {α}_{1} - {α}_{0} )}{cos ( {α}_{2} - {α}_{0} )} = \frac{cos {α}_{1} cos {α}_{0} + sin {α}_{1} sin {α}_{0}}{cos {α}_{2} cos {α}_{0} + sin {α}_{2} sin {α}_{0}} .$$

After deformation, it obtains:

(cos α₁ cos α₀+sin α₁ sin α₀)tan β₂=(cos α₂ cos α₀+sin α₂ sin α₀)tan β₁.

Merging items including α₀ yields:

$$( cos {α}_{1} tan {β}_{2} - cos {α}_{2} tan {β}_{1} ) cos {α}_{0} = sin {α}_{2} tan {β}_{1} - sin {α}_{1} tan {β}_{2} ) sin {α}_{0} , \\ tan {α}_{0} = \frac{sin {α}_{0}}{cos {α}_{0}} = \frac{cos {α}_{1} tan {β}_{2} - cos {α}_{2} tan {β}_{1}}{sin {α}_{2} tan {β}_{1} - sin {α}_{1} tan {β}_{2}} .$$

It then obtains:

$${α}_{0} = {tan}^{- 1} \frac{cos {α}_{1} tan {β}_{2} - cos {α}_{2} tan {β}_{1}}{sin {α}_{2} tan {β}_{1} - sin {α}_{1} tan {β}_{2}} .$$

After α₀ is obtained, it is put into the equation to obtain:

$${β}_{0} = {tan}^{- 1} \frac{tan {β}_{1}}{cos ( {α}_{1} - {α}_{0} )} = {tan}^{- 1} \frac{tan {β}_{2}}{cos ( {α}_{2} - {α}_{0} )} .$$

Since the value range of the horizontal rotation angle is [−π, π], and the value range of the arctangent function is

$$[ - \frac{π}{2} , \frac{π}{2} ] ,$$

the correction is required to be performed on α₀ according to the value of the α₁ and α₂ in the following manner:

$$if \frac{{α}_{1} + {α}_{2}}{2} - {α}_{0} > \frac{π}{2} , then {α}_{0} = {tan}^{- 1} \frac{cos {α}_{1} tan {β}_{ 2} - cos {α}_{2} tan {β}_{1}}{sin {α}_{2} tan {β}_{1} - sin {α}_{1} tan {β}_{2}} + π ;$$

$$if \frac{{α}_{1} + {α}_{2}}{2} - {α}_{0} < \frac{π}{2} , then {α}_{0} = {tan}^{- 1} \frac{cos {α}_{1} tan {β}_{ 2} - cos {α}_{2} tan {β}_{1}}{sin {α}_{2} tan {β}_{1} - sin {α}_{1} tan {β}_{2}} - π .$$

Therefore, the edge to be calibrated can be calibrated. In actual operation, a plurality of points on the edge to be calibrated can be estimated to obtain estimated values of a plurality of groups of (α₀, β₀), and finally the estimated values are averaged so as to improve the accuracy of estimation.

It will be appreciated that, for a point (α, β) on the wall surface, if tan β=tan β₀ cos (α−α₀), it indicates that the point is located on the edge to be calibrated (or an extension line thereof); if tan β<tan β₀ cos (α−α₀), it indicates that the point is positioned below the edge to be calibrated; and if tan β>tan β₀ cos (α−α₀), it indicates that the point is positioned above the edge to be calibrated.

According to the embodiment of the disclosure, the horizontal line on the wall surface can be calibrated by the method of acquiring a first rotation parameter and a second rotation parameter when a center of a projection picture of the calibration apparatus directly faces two points on an edge to be calibrated respectively and determining an edge calibration parameter when the center of the projection picture of the calibration apparatus directly faces the edge to be calibrated according to the first rotation parameter and the second rotation parameter.

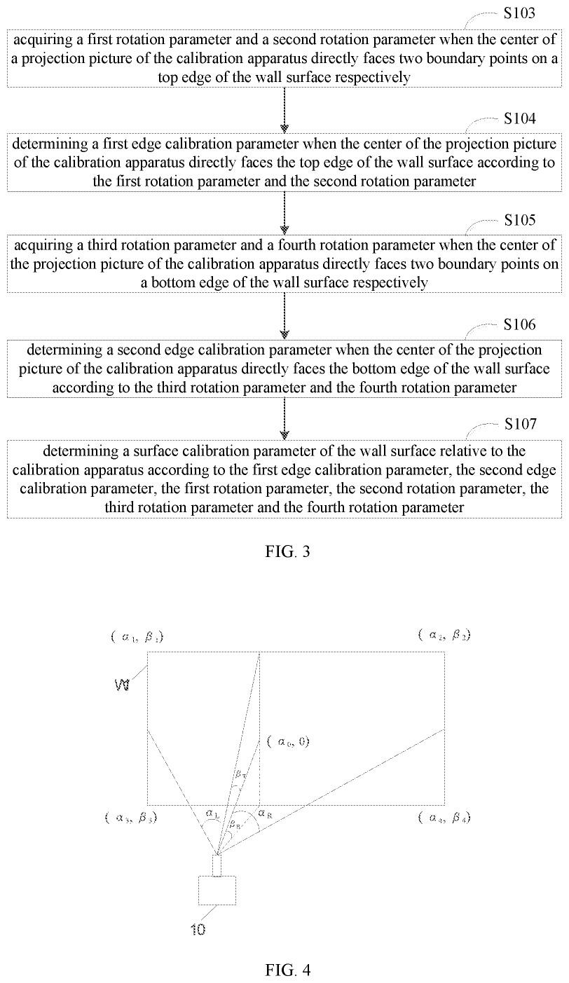

Further, with reference to FIG. 3, it is a flow diagram of a method for wall surface calibration provided by the embodiment of the present disclosure.

Specifically, the method for wall surface calibration includes the following operations.

Operation S103, acquiring a first rotation parameter and a second rotation parameter when the center of a projection picture of the calibration apparatus directly faces two boundary points on a top edge of the wall surface respectively.

Referring to FIG. 4, the calibration apparatus 10 is adjusted so that the center of the projection picture thereof directly faces two boundary points of the top edge of the wall surface W1 to obtain the horizontal rotation angle and the vertical rotation angle of the calibration apparatus at this time, thereby obtaining the first rotation parameter (α₁, β₁) and the second rotation angle (α₂, β₂).

Operation S104, determining a first edge calibration parameter when the center of the projection picture of the calibration apparatus directly faces the top edge of the wall surface according to the first rotation parameter and the second rotation parameter.

According to the method in the first embodiment, the first edge calibration parameter (a₀, β_{T}) when the center of the projection picture of the calibration apparatus directly faces the top edge of the wall surface can be determined according to the first rotation parameter (α₁, β₁) and the second rotation parameter (α₂, β₂), wherein α₀ is the horizontal rotation angle when the calibration apparatus directly faces the wall surface, and PT is the vertical rotation angle when the center of the projection picture of the calibration apparatus directly faces the top edge of the wall surface.

It will be appreciated that:

$${β}_{T} = {β}_{1} = {β}_{2} , and$$

$${α}_{0} = {tan}^{- 1} \frac{cos {α}_{1} tan {β}_{T} - cos {α}_{2} tan {β}_{T}}{sin {α}_{2} tan {β}_{T} - sin {α}_{1} tan {β}_{T}} .$$

Operation S105, acquiring a third rotation parameter and a fourth rotation parameter when the center of the projection picture of the calibration apparatus directly faces two boundary points on a bottom edge of the wall surface respectively.

Referring to FIG. 4, the calibration apparatus 10 is adjusted so that the center of the projection picture thereof directly faces two boundary points of the bottom edge of the wall surface W1 to obtain the horizontal rotation angle and the vertical rotation angle of the calibration apparatus at this time, thereby obtaining the third rotation parameter (α₃, β₃) and the fourth rotation angle (α₄, β₄).

Operation S106, determining a second edge calibration parameter when the center of the projection picture of the calibration apparatus directly faces the bottom edge of the wall surface according to the third rotation parameter and the fourth rotation parameter.

The second edge calibration parameter (α₀, β_{B}) includes the horizontal rotation angle α₀ when the calibration apparatus directly faces the wall surface and the vertical rotation angle β_{B} when the center of the projection picture of the calibration apparatus directly faces the bottom edge of the wall surface. It can be understood that the horizontal rotation angle when the calibration apparatus directly faces the wall surface is always equal to α₀, and the calculation formula of the vertical rotation angle β_{B} when the center of the projection picture of the calibration apparatus directly faces the bottom edge of the wall surface is as follows:

β_{B}=β₃=β₄

Operation S107, determining a surface calibration parameter of the wall surface relative to the calibration apparatus according to the first edge calibration parameter, the second edge calibration parameter, the first rotation parameter, the second rotation parameter, the third rotation parameter and the fourth rotation parameter.

Specifically, the determining a surface calibration parameter of the wall surface relative to the calibration apparatus includes determining a horizontal rotation angle α_{L} when the calibration apparatus calibrates a left most edge of the wall surface and a horizontal rotation angle α_{R} when calibrating a right most side of the wall surface according to the first rotation parameter (α₁, β₁), the second rotation parameter (α₂, β₂), the third rotation parameter (α₃, β₃) and the fourth rotation parameter (α₄, β₄); and determining a horizontal rotation angle α₀ when the calibration apparatus directly faces the wall surface, a vertical rotation angle β_{T} when the center of the projection picture of the calibration apparatus directly faces the top edge of the wall surface, and a vertical rotation angle β_{B} when the center of the projection picture of the calibration apparatus directly faces the bottom edge of the wall surface according to the first edge calibration parameter (α₀, β_{T}) and the second edge calibration parameter (α₀, β_{B}) wherein {α_{L}, α_{R}, α₀, β_{T}, β_{B}} constitutes a surface calibration parameter of the wall surface relative to the calibration apparatus.

Since the horizontal rotation angle of the calibration apparatus is only related to the horizontal position and not to the vertical height, it can obtain:

α_{L}=α₁=α₃,

α_{R}=α₂=α₄.

In some embodiments, averaging may be performed to reduce random errors, i.e.:

$${α}_{L} = \frac{{α}_{1} + {α}_{3}}{2} , {α}_{R} = \frac{{α}_{2} + {α}_{4}}{2} .$$

Therefore, the calibration to the vertical wall surface can be completed, and the calibration parameters are {α_{L}, α_{R}, α₀, β_{T}, β_{B}}.

It should be noted that if an area to be avoided, such as a door, a window, furniture and the like, exists on the wall surface W1, the vertical wall surface can be divided into a plurality of areas and then calibrated respectively.

It will be appreciated that for the wall W1, when the center of the projection picture of the calibration apparatus is located on the wall surface W1, the range of the horizontal rotation angle of the calibration apparatus is [α₁, α_{R}]. Therefore, for a point (α, β) of the horizontal rotation angle located between [α_{L}, α_{R}], if tan β_{B} cos (α−α₀)≤tan β≤tan β_{T} cos (α−α₀), it indicates that the point is located on the wall surface W1; if tan β<tan β_{B} cos (α−α₀) it indicates that the point is located below the wall surface W1 (floor); if tan β>tan β_{T} cos(α−α₀) and it indicates that the point is located above the wall W1 (ceiling).

With reference to FIG. 5, it is a schematic diagram of a standard cubic space provided by the embodiment of the present disclosure. Four vertical walls are denoted W1, W2, W3 and W4 respectively, four vertices of the ceiling are denoted A, B, C and D respectively, and four vertices of the floor are denoted E, F, G and H respectively. According to the first rotation parameter (α₁, β₁), the second rotation parameter (α₂, β₂), the third rotation parameter (α₃, β₃) and the fourth rotation parameter (α₄, β₄) corresponding to four points A, B, E and F, the calibration to the wall surface W1 can be realized, namely the surface calibration parameter {α_{L}^{W1}, α_{R}^{W1}, α₀^{W1}, β_{T}^{W1}, β_{B}^{W1}} of the wall surface W1 relative to the calibration apparatus is obtained; and according to the four points B, C, F and G, the calibration to the wall surface W2 can be realized, namely the surface calibration parameter {α_{L}^{W2}, α_{R}^{W2}, α₀^{W2}, β_{T}^{W2}, β_{B}^{W2}} of the wall surface W2 relative to the calibration apparatus is obtained. By analogy, four vertical walls can be calibrated. As can be understood, the calibration to the wall surface can be completed only by using apparatus rotation angles corresponding to eight boundary points in the process, and the operation is simple.

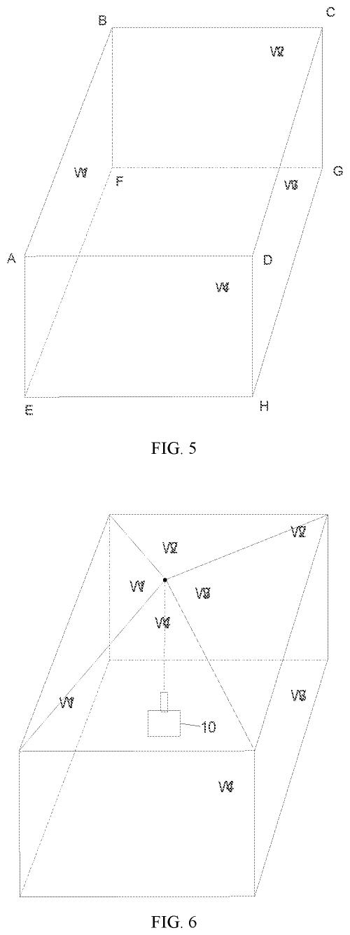

With reference to FIG. 6, it is a schematic diagram of a calibration to a ceiling of a standard space provided by the embodiment of the present disclosure. Centered at a position where the calibration device directly faces the ceiling and connection lines with four boundary points of the ceiling, the ceiling can be divided into four parts to be respectively connected with the nearest vertical wall surface. Therefore, the divided four parts of the ceiling can be respectively considered as part of the four vertical wall surfaces connected therewith.

It will be appreciated that the floor may also be divided into four parts in the manner described above, as well as each being considered part of four vertical walls connected therewith.

It should be noted that for a point (α,β) on the wall surface (including the ceiling and the floor), it is first determined which vertical wall surface it is located based on the horizontal rotation angle α. For example, if α_{L}^{W1}≤α≤α_{R}^{W1}, it indicates that it is located on the vertical wall W1 and the ceiling or floor connected therewith. Then, the specific position is judged according to the vertical rotation angle. If tan β_{B}^{W1} cos (α−α₀^{W1})≤tan β≤tan β_{T}^{W1} cos (α−α₀^{W1}), it indicates that the point is located on the vertical wall W1; if tan β<tan β_{B}^{W1} cos (α−α₀^{W1}), it indicates that the point is located in the floor area connected with the W1; and if tan β>tan β_{T}^{W1} cos (α−α₀^{W1}, it indicates that this point is located in the ceiling region connected with W1.

According to the embodiment, the disclosure includes acquiring a first rotation parameter and a second rotation parameter when the center of a projection picture of the calibration apparatus directly faces two boundary points on a top edge of the wall surface respectively; determining a first edge calibration parameter when the center of the projection picture of the calibration apparatus directly faces the top edge of the wall surface according to the first rotation parameter and the second rotation parameter; acquiring a third rotation parameter and a fourth rotation parameter when the center of the projection picture of the calibration apparatus directly faces two boundary points on a bottom edge of the wall surface respectively; determining a second edge calibration parameter when the center of the projection picture of the calibration apparatus directly faces the bottom edge of the wall surface according to the third rotation parameter and the fourth rotation parameter; and determining a surface calibration parameter of the wall surface relative to the calibration apparatus according to the first edge calibration parameter, the second edge calibration parameter, the first rotation parameter, the second rotation parameter, the third rotation parameter and the fourth rotation parameter. The wall surface, a ceiling and a floor connected with the wall surface can be calibrated according to the first rotation parameter, the second rotation parameter, the third rotation parameter and the fourth rotation parameter. As the space is composed of four wall surfaces, the ceiling and the floor connected with the four wall surfaces and has only eight boundary points, the calibration to the space can be realized by only 8 rotation parameters by means of the method, which is very simple.

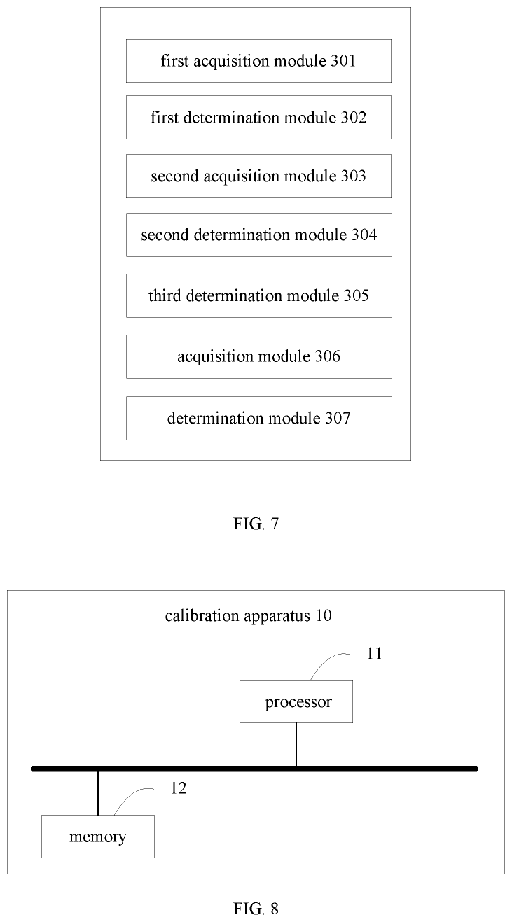

Further, with reference to FIG. 7, it is a schematic diagram of a wall surface calibration and an edge calibration device according to an embodiment of the present disclosure.

Notably, the term “module” as used in embodiments of the present disclosure is a combination of software and/or hardware that may implement predetermined functions.

Although the device described in the embodiments below may be implemented in software, implementations in hardware, or a combination of software and hardware, are also contemplated.

Specifically, a device for wall surface and edge calibration includes the following modules.

A first acquisition module 301 configured for acquiring a first rotation parameter and a second rotation parameter when the center of a projection picture of the calibration apparatus directly faces two boundary points on a top edge of the wall surface respectively.

A first determination module 302 configured for determining a first edge calibration parameter when the center of the projection picture of the calibration apparatus directly faces the top edge of the wall surface according to the first rotation parameter and the second rotation parameter.

A second acquisition module 303 configured for acquiring a third rotation parameter and a fourth rotation parameter when the center of the projection picture of the calibration apparatus directly faces two boundary points on a bottom edge of the wall surface respectively.

A second determination module 304 configured for determining a second edge calibration parameter when the center of the projection picture of the calibration apparatus directly faces the bottom edge of the wall surface according to the third rotation parameter and the fourth rotation parameter.

A third determination module 305 configured for determining a surface calibration parameter of the wall surface relative to the calibration apparatus according to the first edge calibration parameter, the second edge calibration parameter, the first rotation parameter, the second rotation parameter, the third rotation parameter and the fourth rotation parameter.

In some embodiments, the third determination module 305 is specifically configured for the following operations.

Determining a horizontal rotation angle α_{L} when the calibration apparatus calibrates a left most edge of the wall surface and a horizontal rotation angle α_{R} when calibrating a right most side of the wall surface according to the first rotation parameter (α₁, β₁), the second rotation parameter (α₂, β₂), the third rotation parameter (α₃, β₃) and the fourth rotation parameter (α₄, β₄).

Determining a horizontal rotation angle α₀ when the calibration apparatus directly faces the wall surface, a vertical rotation angle β_{T} when the center of the projection picture of the calibration apparatus directly faces the top edge of the wall surface, and a vertical rotation angle β_{B} when the center of the projection picture of the calibration apparatus directly faces the bottom edge of the wall surface according to the first edge calibration parameter (α₀, β_{T}) and the second edge calibration parameter (α₀, β_{B}), wherein {α_{L}, α_{R}, α₀, β_{T}, β_{B}} constitutes a surface calibration parameter of the wall surface relative to the calibration apparatus.

A calculation formula for determining a horizontal rotation angle α_{L} when the calibration apparatus calibrates a left most edge of the wall surface is as follows:

$${α}_{L} = \frac{{α}_{1} + {α}_{3}}{2} .$$

A calculation formula for a horizontal rotation angle α_{R} when calibrating a right most side of the wall surface is as follows:

$${α}_{R} = \frac{{α}_{2} + {α}_{4}}{2} .$$

A calculation formula for determining a first edge calibration parameter (α₀, β_{T}) when the center of the projection picture of the calibration apparatus directly faces the top edge of the wall surface according to the first rotation parameter (α₁, β₁) and the second rotation parameter (α₂, β₂) is as follows:

$${β}_{T} = {β}_{1} = {β}_{2} , and$$

$${α}_{0} = {tan}^{- 1} \frac{cos {α}_{1} tan {β}_{T} - cos {α}_{2} tan {β}_{T}}{sin {α}_{2} tan {β}_{T} - sin {α}_{1} tan {β}_{T}} .$$

A calculation formula for determining a second edge calibration parameter (α₀, β_{B}) when the center of the projection picture of the calibration apparatus directly faces the bottom edge of the wall surface according to the third rotation parameter (α₃, β₃) and the fourth rotation parameter (α₄, β₄) is as follows:

β_{B}=β₃=β₄

Further, the device for wall surface and edge calibration further includes the following modules.

An acquisition module 306 configured for acquiring a first rotation parameter and a second rotation parameter when the center of a projection picture of the calibration apparatus directly faces two points on an edge to be calibrated respectively.

A determination module 307 configured for determining an edge calibration parameter when the center of the projection picture of the calibration apparatus directly faces the edge to be calibrated according to the first rotation parameter and the second rotation parameter.

A calculation formula for determining an edge calibration parameter α₀ when the center of the projection picture of the calibration apparatus directly faces the edge to be calibrated according to the first rotation parameter (α₁, β₁) and the second rotation parameter (α₂, β₂) is as follows:

$${α}_{0} = {tan}^{- 1} \frac{cos {α}_{1} tan {β}_{2} - cos {α}_{2} tan {β}_{1}}{sin {α}_{2} tan {β}_{ 1} - sin {α}_{1} tan {β}_{2}} .$$

The value range of the horizontal rotation angle is [−π, π] and the value range of the arctangent function is

$$⌊ - \frac{π}{2} , \frac{π}{2} ⌋ ;$$

therefore,

$$if \frac{{α}_{1} + {α}_{2}}{2} - {α}_{0} > \frac{π}{2} , then$$

$${α}_{0} = {tan}^{- 1} \frac{cos {α}_{1} tan {β}_{2} - cos {α}_{2} tan {β}_{1}}{sin {α}_{2} tan {β}_{1} - sin {α}_{1} tan {β}_{2}} + π ; and if$$

$$\frac{{α}_{1} + {α}_{2}}{2} - {α}_{0} < - \frac{π}{2} , then$$

$${α}_{0} = {tan}^{- 1} \frac{cos {α}_{1} tan {β}_{2} - cos {α}_{2} tan {β}_{1}}{sin {α}_{2} tan {β}_{1} - sin {α}_{1} tan {β}_{2}} - π .$$

According to the embodiment, the disclosure includes acquiring a first rotation parameter and a second rotation parameter when the center of a projection picture of the calibration apparatus directly faces two boundary points on a top edge of the wall surface respectively; determining a first edge calibration parameter when the center of the projection picture of the calibration apparatus directly faces the top edge of the wall surface according to the first rotation parameter and the second rotation parameter; acquiring a third rotation parameter and a fourth rotation parameter when the center of the projection picture of the calibration apparatus directly faces two boundary points on a bottom edge of the wall surface respectively; determining a second edge calibration parameter when the center of the projection picture of the calibration apparatus directly faces the bottom edge of the wall surface according to the third rotation parameter and the fourth rotation parameter; and determining a surface calibration parameter of the wall surface relative to the calibration apparatus according to the first edge calibration parameter, the second edge calibration parameter, the first rotation parameter, the second rotation parameter, the third rotation parameter and the fourth rotation parameter. The wall surface, a ceiling and a floor connected with the wall surface can be calibrated according to the first rotation parameter, the second rotation parameter, the third rotation parameter and the fourth rotation parameter. As the space is composed of four wall surfaces, the ceiling and the floor connected with the four wall surfaces and has only eight boundary points, the calibration to the space can be realized by only 8 rotation parameters by means of the method, which is very simple.

Further, with reference to FIG. 8, it is a schematic diagram of a hardware structure of a calibration apparatus for performing the wall surface and the edge calibration according to the embodiment of the present disclosure, and the calibration apparatus 10 includes one or more processors 11 and a memory 12; wherein, the processor 11 is illustrated as an example in FIG. 8.

The processor 11 and the memory 12 may be connected by a bus or other means, exemplified by a bus connection in FIG. 8.

As a non-volatile computer-readable storage medium, the memory 12 can be used for storing non-volatile software programs, non-volatile computer-executable programs and modules, program instructions corresponding to the method for wall surface and edge calibration, and modules corresponding to the device for wall surface and edge calibration in the above-mentioned embodiments of the present disclosure (for example, a first acquisition module 301, a first determination module 302, a second acquisition module 303, a second determination module 304, a third determination module 305, an acquisition module 306, a determination module 307 and the like). The processor 11 executes various functional applications and data processing of the method for wall surface and edge calibration by running non-volatile software programs, instructions and modules stored in the memory 12, i.e. implementing the method for wall surface and edge calibration of the above-described method embodiments and the functions of the various modules of the above-described device embodiments.

The memory 12 may include a storage program area and a storage data area, wherein the storage program area may store an operating system, and an application program required for at least one function; and the storage data area may store data created according to the use of the device for wall surface and edge calibration, etc.

In addition, the memory 12 may include a high speed random access memory, and may also include a non-volatile memory, such as at least one magnetic disk storage device, a flash memory device, or other non-volatile solid state memory device. In some embodiments, the memory 12 may optionally include a memory remotely located relative to processor 11, which may be connected to the processor 11 via a network. Examples of such networks include, but are not limited to, the Internet, intranets, local area networks, mobile communication networks, and combinations thereof.

The program instructions and one or more modules are stored in the memory 12 and, when executed by the one or more processors 11, perform the operations of the method for wall surface and edge calibration in any of the method embodiments described above, or perform the functions of the modules of one of the device embodiments described above and one of the device embodiments described above.

The product can execute the method provided by the embodiment of the disclosure, and has corresponding functional modules and beneficial effects. Reference will now be made in detail to the methods of the present disclosure for technical details not fully described in this embodiment.

Embodiments of the present disclosure also provide a non-volatile computer-readable storage medium having computer-executable instructions stored thereon for execution by one or more processors, such as a processor 11 of FIG. 8, that cause the computer to perform the operations of the method for wall surface and edge calibration of any of the method embodiments described above, or realize the functions of each module of the device for wall surface and edge calibration in any device embodiment.

Embodiments of the present disclosure also provide a computer program product comprising program code which, when run on a calibration apparatus, causes the calibration device to be capable of performing the operations of the method for wall surface and edge calibration in any of the method embodiments described above, or of performing the functions of the modules of the device for wall surface and edge calibration in any of the device embodiments described above.

The device embodiments described above are merely illustrative, wherein the modules illustrated as separate elements may or may not be physically separate, and the components shown as modules may or may not be physical elements, i.e., may be located at one place, or may be distributed across multiple network elements. Some or all of the modules can be selected according to actual needs to achieve the purpose of the solution of the embodiment.

From the above description of the embodiments, it will be clear to a person skilled in the art that the embodiments may be implemented by means of software plus a general purpose hardware platform, but of course also by means of hardware. It will be appreciated by those of ordinary skill in the art that all or part of the processes for implementing the above-described embodiments may be performed by hardware associated with computer program instructions, and the program may be stored on a computer-readable storage medium, and may include the processes for implementing the methods as described above when executed. The storage medium may be a magnetic disk, an optical disk, a read-only memory (ROM), a random access memory (RAM), or the like.

The above mentioned is merely exemplary of the present disclosure, and is not intended to limit the scope of the present disclosure. Any equivalent structure or equivalent process transformation made by using the content of the description and drawings of this disclosure, or directly or indirectly used in other related technical fields, are similarly included in the scope of patent protection of this disclosure.

Finally, it should be noted that the embodiments are merely illustrative of the technical solution of the present disclosure and are not intended to be limiting thereof; the embodiments or technical features in different embodiments may also be combined under the idea of the present disclosure, the operations may be performed in any order, and there are many other variations of the different aspects of the present disclosure as described above, which are not provided in detail for the sake of brevity; although the present disclosure has been described in detail with reference to the foregoing embodiments, those skilled in the art will appreciate that the technical solution of the above-mentioned embodiments can still be modified, or some of the technical features thereof can be equivalently replaced; and these modifications and substitutions do not depart from the scope of the embodiments of the present disclosure.

1. A method for wall surface calibration applied to a calibration apparatus, comprising:
acquiring a first rotation parameter and a second rotation parameter when a center of a projection picture of the calibration apparatus directly faces two boundary points on a top edge of the wall surface respectively;
determining a first edge calibration parameter when the center of the projection picture of the calibration apparatus directly faces the top edge of the wall surface according to the first rotation parameter and the second rotation parameter;
acquiring a third rotation parameter and a fourth rotation parameter when the center of the projection picture of the calibration apparatus directly faces two boundary points on a bottom edge of the wall surface respectively;
determining a second edge calibration parameter when the center of the projection picture of the calibration apparatus directly faces the bottom edge of the wall surface according to the third rotation parameter and the fourth rotation parameter; and
determining a surface calibration parameter of the wall surface relative to the calibration apparatus according to the first edge calibration parameter, the second edge calibration parameter, the first rotation parameter, the second rotation parameter, the third rotation parameter and the fourth rotation parameter.

2. The method according to claim 1, wherein the determining a surface calibration parameter of the wall surface relative to the calibration apparatus specifically comprises:
determining a horizontal rotation angle α_{L} when the calibration apparatus calibrates a left most edge of the wall surface and a horizontal rotation angle α_{R} when calibrating a right most side of the wall surface according to the first rotation parameter (α₁, β₁) the second rotation parameter (α₂, β₂), the third rotation parameter (α₃, β₃) and the fourth rotation parameter (α₄, β₄); and
determining a horizontal rotation angle α₀ when the calibration apparatus directly faces the wall surface, a vertical rotation angle β_{T} when the center of the projection picture of the calibration apparatus directly faces the top edge of the wall surface, and a vertical rotation angle β_{B} when the center of the projection picture of the calibration apparatus directly faces the bottom edge of the wall surface according to the first edge calibration parameter (α₀, β_{T}) and the second edge calibration parameter (α₀, β_{B}), wherein {α_{L}, α_{R}, α₀, β_{T}, β_{B}} constitutes a surface calibration parameter of the wall surface relative to the calibration apparatus.

3. The method according to claim 2, wherein a calculation formula for determining a horizontal rotation angle α_{L} when the calibration apparatus calibrates a left most edge of the wall surface is as follows:
$${α}_{L} = \frac{{α}_{1} + {α}_{3}}{2} ,$$
and
a calculation formula for a horizontal rotation angle α_{R} when calibrating a right most side of the wall surface is as follows:
$${α}_{R} = \frac{{α}_{2} + {α}_{4}}{2} .$$

4. The method according to claim 2, wherein a calculation formula for determining a first edge calibration parameter (α₀, β_{T}) when the center of the projection picture of the calibration apparatus directly faces the top edge of the wall surface according to the first rotation parameter (α₁, β₁) and the second rotation parameter (α₂, β₂) is as follows:
$${β}_{T} = {β}_{1} = {β}_{2} , and$$
$${α}_{0} = {tan}^{- 1} \frac{cos {α}_{1} tan {β}_{T} - cos {α}_{2} tan {β}_{T}}{sin {α}_{2} tan {β}_{T} - sin {α}_{1} tan {β}_{T}} .$$

5. The method according to claim 2, wherein a calculation formula for determining a second edge calibration parameter (α₀, β_{B}) when the center of the projection picture of the calibration apparatus directly faces the bottom edge of the wall surface according to the third rotation parameter (α₃, β₃) and the fourth rotation parameter (α₄, β₄) is as follows:
β_{B}=β₃=β₄.

6. A method for edge calibration applied to a calibration apparatus, comprising:
acquiring a first rotation parameter and a second rotation parameter when a center of a projection picture of the calibration apparatus directly faces two points on an edge to be calibrated respectively; and
determining an edge calibration parameter when the center of the projection picture of the calibration apparatus directly faces the edge to be calibrated according to the first rotation parameter and the second rotation parameter.

7. The method according to claim 6, wherein a calculation formula for determining an edge calibration parameter α₀ when the center of the projection picture of the calibration apparatus directly faces the edge to be calibrated according to the first rotation parameter (α₁, β₁) and the second rotation parameter (α₂, β₂) is as follows:
$${α}_{0} = {tan}^{- 1} \frac{cos {α}_{1} tan {β}_{2} - cos {α}_{2} tan {β}_{1}}{sin {α}_{2} tan {β}_{1} - sin {α}_{1} tan {β}_{2}} .$$

8. The method according to claim 7, wherein
the value range of the horizontal rotation angle is [−π, π] and the value range of the arctangent function is
$$⌊ - \frac{π}{2} , \frac{π}{2} ⌋ ;$$
therefore,
$$if \frac{{α}_{1} + {α}_{2}}{2} - {α}_{0} > \frac{π}{2} , then$$
$${α}_{0} = {tan}^{- 1} \frac{cos {α}_{1} tan {β}_{2} - cos {α}_{2} tan {β}_{1}}{sin {α}_{2} tan {β}_{1} - sin {α}_{1} tan {β}_{2}} + π ; and if$$
$$\frac{{α}_{1} + {α}_{2}}{2} - {α}_{0} < - \frac{π}{2} , then$$
$${α}_{0} = {tan}^{- 1} \frac{cos {α}_{1} tan {β}_{2} - cos {α}_{2} tan {β}_{1}}{sin {α}_{2} tan {β}_{1} - sin {α}_{1} tan {β}_{2}} - π .$$

9. A calibration apparatus, comprising:
at least one processor, and
a non-transitory memory communicatively connected to the at least one processor, wherein the memory stores instructions executable by the at least one processor, and the instructions are executed to enable the at least one processor to perform a method for wall surface calibration comprising:
acquiring a first rotation parameter and a second rotation parameter when a center of a projection picture of the calibration apparatus directly faces two boundary points on a top edge of the wall surface respectively;
determining a first edge calibration parameter when the center of the projection picture of the calibration apparatus directly faces the top edge of the wall surface according to the first rotation parameter and the second rotation parameter;
acquiring a third rotation parameter and a fourth rotation parameter when the center of the projection picture of the calibration apparatus directly faces two boundary points on a bottom edge of the wall surface respectively;
determining a second edge calibration parameter when the center of the projection picture of the calibration apparatus directly faces the bottom edge of the wall surface according to the third rotation parameter and the fourth rotation parameter; and
determining a surface calibration parameter of the wall surface relative to the calibration apparatus according to the first edge calibration parameter, the second edge calibration parameter, the first rotation parameter, the second rotation parameter, the third rotation parameter and the fourth rotation parameter.

10. The calibration apparatus according to claim 9, wherein the determining a surface calibration parameter of the wall surface relative to the calibration apparatus specifically comprises:
determining a horizontal rotation angle α_{L} when the calibration apparatus calibrates a left most edge of the wall surface and a horizontal rotation angle α_{R} when calibrating a right most side of the wall surface according to the first rotation parameter (α₁, β₁), the second rotation parameter (α₂, β₂), the third rotation parameter (α₃, β₃) and the fourth rotation parameter (α₄, β₄); and
determining a horizontal rotation angle α₀ when the calibration apparatus directly faces the wall surface, a vertical rotation angle β_{T} when the center of the projection picture of the calibration apparatus directly faces the top edge of the wall surface, and a vertical rotation angle β_{B} when the center of the projection picture of the calibration apparatus directly faces the bottom edge of the wall surface according to the first edge calibration parameter (α₀, β_{T}) and the second edge calibration parameter (α₀, β_{B}), wherein {α_{L}, α_{R}, α₀, β_{T}, β_{B}} constitutes a surface calibration parameter of the wall surface relative to the calibration apparatus.

11. The calibration apparatus according to claim 10, wherein a calculation formula for determining a horizontal rotation angle α_{L} when the calibration apparatus calibrates a left most edge of the wall surface is as follows:
$${α}_{L} = \frac{{α}_{1} + {α}_{3}}{2} ,$$
and
a calculation formula for a horizontal rotation angle α_{R} when calibrating a right most side of the wall surface is as follows:
$${α}_{R} = \frac{{α}_{2} + {α}_{4}}{2} .$$

12. The calibration apparatus according to claim 10, wherein a calculation formula for determining a first edge calibration parameter (α₀, β_{T}) when the center of the projection picture of the calibration apparatus directly faces the top edge of the wall surface according to the first rotation parameter (α₁, β₁) and the second rotation parameter (α₂, β₂) is as follows:
$${β}_{T} = {β}_{1} = {β}_{2} , and$$
$${α}_{0} = {tan}^{- 1} \frac{cos {α}_{1} tan {β}_{T} - cos {α}_{2} tan {β}_{T}}{sin {α}_{2} tan {β}_{T} - sin {α}_{1} tan {β}_{T}} .$$

13. The calibration apparatus according to claim 10, wherein a calculation formula for determining a second edge calibration parameter (α₀, β_{B}) when the center of the projection picture of the calibration apparatus directly faces the bottom edge of the wall surface according to the third rotation parameter (α₃, β₃) and the fourth rotation parameter (α₄, β₄) is as follows:
β_{B}=β₃=β₄.

14. A computer program product comprising program code which, when run on a calibration apparatus, causes the calibration apparatus to perform a method for edge calibration comprising:
acquiring a first rotation parameter and a second rotation parameter when a center of a projection picture of the calibration apparatus directly faces two points on an edge to be calibrated respectively; and
determining an edge calibration parameter when the center of the projection picture of the calibration apparatus directly faces the edge to be calibrated according to the first rotation parameter and the second rotation parameter.

15. The computer program product according to claim 14, wherein a calculation formula for determining an edge calibration parameter α₀ when the center of the projection picture of the calibration apparatus directly faces the edge to be calibrated according to the first rotation parameter (α₁, β₁) and the second rotation parameter (α₂, β₂) is as follows:
$${α}_{0} = {tan}^{- 1} \frac{cos {α}_{1} tan {β}_{2} - cos {α}_{2} tan {β}_{1}}{sin {α}_{2} tan {β}_{1} - sin {α}_{1} tan {β}_{2}} .$$

16. The computer program product according to claim 15, wherein
the value range of the horizontal rotation angle is [−π, π] and the value range of the arctangent function is
$$⌊ - \frac{π}{2} , \frac{π}{2} ⌋ ;$$
therefore,
$$if \frac{{α}_{1} + {α}_{2}}{2} - {α}_{0} > \frac{π}{2} , then$$
$${α}_{0} = {tan}^{- 1} \frac{cos {α}_{1} tan {β}_{2} - cos {α}_{2} tan {β}_{1}}{sin {α}_{2} tan {β}_{1} - sin {α}_{1} tan {β}_{2}} + π ; and if$$
$$\frac{{α}_{1} + {α}_{2}}{2} - {α}_{0} < - \frac{π}{2} , then$$
$${α}_{0} = {tan}^{- 1} \frac{cos {α}_{1} tan {β}_{2} - cos {α}_{2} tan {β}_{1}}{sin {α}_{2} tan {β}_{1} - sin {α}_{1} tan {β}_{2}} - π .$$
